(19) United States
(12) Patent Application Publication
(10) Pub. No.: US 2014/0136276 A1
(43) Pub. Date: May 15, 2014

(54) QUANTITATIVE RISK ASSESSMENT METHODS AND SYSTEMS FOR RENEWABLE AND NON-RENEWABLE ENERGY PROJECTS

(71) Applicant: Applied Reliability Solutions Ltd., Calgary (CA)

(72) Inventors: Alexander Charles Creagh, Calgary (CA); Crystal Charmaine Waters, Calgary (CA)

(73) Assignee: Applied Reliability Solutions Ltd., Calgary (CA)

(21) Appl. No.: 14/070,332

(22) Filed: Nov. 1, 2013

Related U.S. Application Data
(60) Provisional application No. 61/722,670, filed on Nov. 5, 2012.

(51) Int. Cl. G06Q 10/06

(52) U.S. Cl. CPC G06Q 10/0635
USPC 705/7.28

(57) ABSTRACT

A quantitative based risk assessment process is disclosed. The process includes the identification of parameters and sub-parameters relating to socio/economic, environmental and project construction risks in providing a quality risk assessment of a region and/or project for renewable and non-renewable energy projects. Risks parameters are variable and can be selected from a number of predetermined categories as needed for each project and can be weighted differently based on the needs and/or goals of the project and the impact thereof. Systems, storage devices and mediums and outputs of same are also provided.

### RELATED APPLICATIONS

This application claims the benefit of U.S. Provisional Application No. 61/722,670, filed Nov. 5, 2012, and entitled Quantitative Risk Assessment Methods and Systems For Renewable and Non-Renewable Energy Projects, which is incorporated by reference in its entirety.

### BACKGROUND

1. Field

The technology relates to methods and systems for assessing and/or characterizing risk parameters such as socio-economic, environmental and/or construction risk and impact of industrial projects and more specifically to renewable and non-renewable energy projects.

2. Description of Related Art

Current socio-economic, environmental and construction risk assessment practices associated with development projects including renewable energy projects, such as wind, bio-fuel, solar, etc., and non-renewable energy projects, such as oil and gas, power generation, etc., are centered on qualitative risk assessment processes. Qualitative risk assessment processes rely heavily on pre-defined best industry practices or expert/industry professional opinion. Potential or realized adverse project affects are identified through field-based assessment programs and mitigated at localized scales or site-specific locations.

Various challenges to current risk assessment programs can include one or more of the following.
A method/process that removes the subjective nature associated with individual(s) judgement, interpretation, definition and mitigation of project risk.
A method/process that defines a “representative contrast” to assess and measure perceived, potential and/or realized project risks to alternate areas defined at varying spatial and/or temporal scales across a landscape.
A method/process that is flexible to integrate data collected from multiple sources that include but are not limited to: high resolution aerial photography/satellite, geophysical studies and field-studies (environmental, traditional land use, cultural/heritage).
A method/process that defines, documents and presents options to mitigate project risks from pre-project planning stages through to project completion.
A method/process that demonstrates a proponent's decision, justification and mitigation of project risks that is quantitatively defensible during legal hearings with regulatory authorities and/or stakeholder groups.
A method/process that has the capability to quantitatively assess and measure socio-economic, environmental and construction project risks on a cumulative and/or independent scale.
A method/process that can define project risk in the form of maps or other visual/graphical applications that may be applied to the Project footprint, and more importantly, areas adjacent to or surrounding the project footprint.

With increased pressure on industry to conduct more effective and representative risk assessment programs, there is a need for a risk assessment program for industrial development applications.

### SUMMARY

A qualitative risk assessment process, system and method is provided that takes into account various parameters such as socio/economic, environmental and project construction risks in providing a quality risk assessment of a region and/or project for renewable and non-renewable energy projects. Risks parameters are variable and may be selected from a number of predetermined categories as needed for each project and may be weighted differently based on the needs and/or goals of the project and the impact thereof. Ultimately, the qualitative risk assessment process, systems and methods allow for the impact of renewable and non-renewable energy projects to be generated and hypothesised and then reviewed, reduced, prepared for, or mitigated. It will be appreciated that the qualitative risk assessment processes, systems and methods may also apply to industry projects outside of renewable and non-renewable energy projects such as but not limited to: Wildlife Field Assessment Programs, Vegetation Field Assessment Programs, Archeological & Paleontological Resource Field Assessment Programs, Fisheries, Water Course and Wetland Field Assessment Programs, Geomorphological and Soil Field Assessment Programs, First Nation (FN) Consultation and Field Assessment Programs, Stakeholder Consultation and Field Assessment Programs, and Project Construction Surveying Field Assessment Programs for example.

In one illustrative embodiment of a process for carrying out quantitative risk assessment, the process comprises optionally one, multiple or all of the following.
Categorize project risks into a series of parameters that represent socio-economic, environmental and construction constraints. Define sub-parameter categories and risk rank in order of severity based upon external influences such as for example Provincial and Federal regulations associated with a specific project activities.
Collect GIS data for both proposed and alternate Project footprints. GIS data represent observations within the bounds of both proposed and alternate footprints. Spatial scale and sampling intensity is typically dependent upon the size of the proposed project.
GIS observations are taken from within proposed and alternate project footprints. The risk parameters and sub-parameter rank scores are linked to each observation. The number of observations taken within proposed and alternate project footprints is scale dependent.
Conduct statistical analysis of GIS data, model fit and diagnostic tests, identify statistically significant parameters. Remove non-statistically different parameters for the model to define the final Quantitative Risk Assessment Function (QRAF).
Integrate QRAF into GIS and develop risk maps for socio-economic, environmental and construction risks and a final map that is the cumulative risk for all three categories. Mapping applications may optionally be the final product.

After the party requesting the risk assessment reviews the assessment, the process may be modified through the use of risk mitigation techniques for specific parameters or sub-parameters. After client review, the statistical analysis can be re-run to obtain the revised mapping products.

In one non-limiting embodiment, the technology provides for a method for producing a quantitative risk assessment of one or more geographical development projects associated with one or more geographical regions comprising:
categorizing project risks into a series of risk parameters;
collecting geographic information system (GIS) data on the one or more geographical regions;
linking the GIS data to the risk parameters;
using a weighing/scoring of the risk parameters to produce one or more quantitative risk assessment functions (QRAFs) based on the linked GIS data; and
using the one or more QRAFs and collected GIS data to produce the quantitative risk assessment of the one or more geographical development projects.

In a further embodiment of the method outlined above, the one or more geographical development projects are comprised of a proposed project and an alternate project.

In a further embodiment of the method(s) outlined above, the produced quantitative risk assessment compares the risks associated with each project to determine a comparative risk assessment.

In a further embodiment of the method(s) outlined above, the series of risk parameters comprise parameters representing socio-economic, environmental, and/or construction risks.

In a further embodiment of the method(s) outlined above, the geographical development projects are renewable energy projects.

In a further embodiment of the method(s) outlined above, the geographical development projects are non-renewable energy projects.

In a further embodiment of the method(s) outlined above, the quantitative risk assessment comprises one or more risk maps representing one or more of the project risks associated with the one or more geographical development projects.

In a further embodiment of the method(s) outlined above, each of the one or more risk maps represent one or more of the parameters in the series of risk parameters associated with the project risks of the one or more geographical development projects.

In a further embodiment of the method(s) outlined above, the one or more risk maps represent the cumulative risk for all risk parameters in the series of risk parameters associated with the project risks of the one or more geographical development projects.

In a further embodiment of the method(s) outlined above, the risk parameters further comprise sub-parameter categories.

In a further embodiment of the method(s) outlined above, the quantitative risk assessment comprises one or more risk maps representing one or more of the project risks associated with the one or more geographical development projects.

In a further embodiment of the method(s) outlined above, each of the one or more risk maps represent one or more of the parameters and/or sub-parameters in the series of risk parameters associated with the project risks of the one or more geographical development projects.

In a further embodiment of the method(s) outlined above, the one or more risk maps represent the cumulative risk for all risk parameters and/or sub-parameters in the series of risk parameters associated with the project risks of the one or more geographical development projects.

In a further embodiment of the method(s) outlined above, the one or more QRAFs employ risk ranking processes that are ordinal, continuous, or categorical/discrete.

In a further embodiment of the method(s) outlined above, the one or more QRAFs employ binary and multinomial models for risk assessment.

In a further non-limiting embodiment, the invention provides for a risk assessment system for producing a quantitative risk assessment of one or more geographical development projects associated with one or more geographical regions comprising a non-transitory computer readable memory having recorded thereon statements and instructions for execution by a computer to carry out:
categorizing project risks into a series of risk parameters;
receiving geographic information system (GIS) data on the one or more geographical regions;
linking the GIS data to the risk parameters;
using a weighing/scoring of the risk parameters to produce one or more quantitative risk assessment functions (QRAFs) based on the linked GIS data; and
using the one or more QRAFs and collected GIS data to produce the quantitative risk assessment of the one or more geographical development projects.

In a further embodiment of the system outlined above, the one or more geographical development projects are comprised of a proposed project and an alternate project.

In a further embodiment of the system(s) outlined above, the produced quantitative risk assessment compares the risks associated with each project to determine a comparative risk assessment.

In a further embodiment of the system(s) outlined above, the series of risk parameters comprise parameters representing socio-economic, environmental, and/or construction risks.

In a further embodiment of the system(s) outlined above, the geographical development projects are renewable energy projects.

In a further embodiment of the system(s) outlined above, the geographical development projects are non-renewable energy projects.

In a further embodiment of the system(s) outlined above, the quantitative risk assessment comprises one or more risk maps representing one or more of the project risks associated with the one or more geographical development projects.

In a further embodiment of the system(s) outlined above, each of the one or more risk maps represent one or more of the parameters in the series of risk parameters associated with the project risks of the one or more geographical development projects.

In a further embodiment of the system(s) outlined above, the one or more risk maps represent the cumulative risk for all risk parameters in the series of risk parameters associated with the project risks of the one or more geographical development projects.

In a further embodiment of the system(s) outlined above, the risk parameters further comprise sub-parameter categories.

In a further embodiment of the system(s) outlined above, the quantitative risk assessment comprises one or more risk maps representing one or more of the project risks associated with the one or more geographical development projects.

In a further embodiment of the system(s) outlined above, each of the one or more risk maps represent one or more of the parameters and/or sub-parameters in the series of risk parameters associated with the project risks of the one or more geographical development projects.

In a further embodiment of the system(s) outlined above, the one or more risk maps represent the cumulative risk for all risk parameters and/or sub-parameters in the series of risk parameters associated with the project risks of the one or more geographical development projects.

In a further embodiment of the system(s) outlined above, the one or more QRAFs employ risk ranking processes that are ordinal, continuous, or categorical/discrete.

In a further embodiment of the system(s) outlined above, the one or more QRAFs employ binary and multinomial models for risk assessment.

In a further non-limiting embodiment, the invention provides for a method for quantifying project risks and constraints of a project development for generating a compensation assessment comprising offsets and/or conservation allowances for regulatory approval.

### BRIEF DESCRIPTION OF THE DRAWINGS

FIG. 1, consisting of FIG. 1A to FIG. 1D, shows Table 1 outlining Risk Parameters & Sub-Parameters for an example of a risk assessment project for a Southwest Expansion Loop illustrative of an example of parameters and sub-parameters of a sample project.

FIG. 2, consisting of FIG. 2A to FIG. 2D, shows Table 2 outlining Sub-Parameters Risk Scores for an example of a risk assessment project for a Southwest Expansion Loop illustrative of an example of sub-parameter risk scores of the sample project.

FIG. 3 shows a photo of GIS data acquisition for a risk assessment project for a Southwest Expansion Loop.

FIG. 4 shows Table 3 outlining Data Extract for an example of a risk assessment project for a Southwest Expansion Loop illustrative of an example of data extract of the sample project.

FIG. 5 shows Table 4 outlining Initial QRAF Statistical Analysis Output for an example of a risk assessment project for a Southwest Expansion Loop illustrative of an example of QRAF statistical analysis output of the sample project.

FIG. 6 shows Table 5 outlining Final QRAF Statistical Analysis Output for an example of a risk assessment project for a Southwest Expansion Loop illustrative of an example of QRAF final statistical analysis output of the sample project.

FIG. 7 is a diagram depicting an example of a thermal risk map for a risk assessment project for a Southwest Expansion Loop.

FIG. 8 shows Table 6 outlining Archeological & Paleontological Resources (%) Risk Score Percentage for an example of a risk assessment project for a Southwest Expansion Loop illustrative of an example of archeological and paleontological resources (%) risk score percentage of the sample project.

FIG. 9, consisting of FIG. 9A to FIG. 90, shows a Table outlining optional illustrative parameters and sub-parameters associated to socio/economic, environmental and project construction risks.

### DETAILED DESCRIPTION OF CERTAIN INVENTIVE EMBODIMENTS

The Quantitative Risk Assessment Function (QRAF) process is a tool for defining and assessing project risk. It may be employed at varying spatial scale to assist project scoping, planning, public consultation and regulatory approval processes. The QRAF process typically allows expansion of the capability of current risk assessment practices. Typically, current practices focus only on the area of disturbed lands and mitigate accordingly. The QRAF process encompasses a broader landscape scale employing high resolution spatial data, GIS and advanced statistical analysis.

During the preparation of industrial development applications for regulatory review a party requesting a risk assessment may demonstrate a quantitative decision making process that provides efficient and robust results. When challenged on site-specific locations the party has the ability to demonstrate using visual graphics the underlying issues and their respective choice. With optional adequate regulatory consultation during the preparation of industrial development applications the process for approval with minimal revision speeds the approval process.

Other applications of the QRAF may include mitigation of site-specific risks and where applicable its application and role in the development of compensation plans. In some cases, industrial development such as pipeline developments cannot deviate from specific locations across a landscape due to imposing physical boundaries such as for example mountain ranges and large river crossings. The selection of the available land may be limited and development can only occur in specific areas. The QRAF can demonstrate this issue but also propose compensation in other high risk areas to mitigate the residual effects of the development.

Current industrial development approval requires considerable public consultation for large-scale industrial development. The QRAF process assists public consultation processes and provide a means for the public and other stakeholders to be engaged and where applicable add comment thereby providing data for identifying often unseen Project risks. The QRAF process also provides a tool for engaging First Nation communities and provides a tool for representing qualitative data expressed generally in terms of location or traditional knowledge.

The QRAF process may, in one embodiment, have sufficient flexibility to be presented in the form of portable mobile devices and/or GPS systems that permit a user to record notes, observations and other features while working in the field or presenting at a conference. This automated product removes the need for physical mapping products and allows for complete digitalization of all work and is currently in development.

The quantitative risk assessment process may include the following steps. It will be appreciated that some of which are optional with respect to amendment of the assessment following an initial preparation and further that the output of the assessment may be done in any suitable manner and may be done using an automated system, computer or storage device or storage medium. The following steps are meant to be illustrative and are not intended to be limiting in any way. One quantitative risk assessment process comprises optionally all of the following.
Categorize project risks into a series of parameters that represent socio-economic, environmental and construction constraints. Define sub-parameter categories and risk rank in order of severity based upon external influences, such as for example, Provincial and Federal regulations associated with a specific project activities.
Collect GIS data for both proposed and alternate Project footprints. GIS data represent observations within the bounds of both proposed and alternate footprints. Spatial scale and sampling intensity is typically dependent upon the size of the proposed project.
GIS observations are taken from within proposed and alternate project footprints. The risk parameters and sub-parameter rank scores are linked to each observation. The number of observations taken within proposed and alternate project footprints is scale dependent.
Conduct statistical analysis of GIS data, model fit and diagnostic tests, identify statistically significant parameters. Remove non-statistically different parameters for the model to define the final Quantitative Risk Assessment Function (QRAF).
Integrate QRAF into GIS and develop risk maps for socio-economic, environmental and construction risks and a final map that is the cumulative risk for all three categories. Mapping applications may optionally be the final product.
After the party requesting the risk assessment reviews the assessment, the process may be modified through the use of risk mitigation techniques for specific parameters or sub-parameters. After client review, the statistical analysis can be re-run to obtain the revised mapping products

The following sample project is meant only to illustrate the application of a Quantitative Risk Assessment Function and is not meant to be limiting in any way. It will be appreciated that various modifications to the process may be carried out without departing from the process and further that the parameters and sub-parameters may vary between projects. In addition, it will be appreciated that a quantitative risk assessment may be generated and output for use by a third party and such generation and output by a computer, storage device or medium, and/or a system for generating and optionally outputting a quantitative risk assessment is within the scope of the technology. Further, the process steps for the generation of a quantitative risk assessment are within the scope of the technology as are the process steps for the output of the quantitative risk assessment for allowing mitigation of impact and/or risk.

Illustrative Sample Project

A permit for the construction of a pipeline expansion project referred to as the Southwest Expansion Loop (the Project) is being applied for. The Project includes the construction of a 50 km pipeline loop to provide adequate capacity to transport natural gas supply from northeast British Columbia and northwest Alberta.

Segments of the Project traverse or are in close proximity to a sensitive wildlife habitat, culturally significant areas and mountainous terrain. A Quantitative Risk Assessment Function (QRAF) of the proposed Southwest Expansion Loop and adjacent lands is to be carried out. Project goals include:
Identify high risk parameters associated with the proposed Project,
Identify significant risk parameters between the proposed and alternate landscapes, and
Identify risk parameters needing Project-specific mitigation, where applicable.

The following demonstrate the QRAF process and identify Project-specific risk mitigation techniques applied to pipeline route selection and other planning requirements for the proposed development.

It is anticipated that this document and technical information within can form part of an Application for Development and may be filed with the National Energy Board (NEB).

The exemplary Project includes the construction of a 50 km pipeline loop to provide adequate capacity to transport natural gas supply from northeast British Columbia and northwest Alberta. The project traverses the British Columbia/Alberta Provincial border and thus is regulated under Federal jurisdiction via the National Energy Board (NEB).

A Quantitative Risk Assessment Function (QRAF) was developed on lands encompassing both the proposed and alternate pipeline routes. The QRAF is based on the total area of both proposed and alternate lands. For the purposes of this Project, risk assessment cannot extend or extrapolate past the total Project area.

The total Project area for QRAF assessment is 600 km². Proposed lands extend 1 km on either side of the centerline of the pipeline route encompassing a total area of 100 km² (2 km width×50 km length). Alternate lands (risk contrast) were defined as 5 km each side of the proposed lands buffer and encompassed an area of 500 km² (10 km width×50 km length).

High-resolution photographic data (LIDAR Data) of the Project boundary was digitalized using Geographic Information System (GIS) software. LIDAR data is used to define the following landscape biophysical features:
Topography and Slope/Sidehill (LIDAR)
Distance to Biophysical Feature (LIDAR and applicable biophysical data source)

Additional data sources defining other biophysical features of the Project area were obtained from respective government regulatory sources and other third-party providers. These include:
Wildlife (Alberta Environment; BC Ministry of Environment; Environment Canada)
Vegetation (Alberta Environment; BC Ministry of Environment; Environment Canada)
Water Resources and Fisheries (Dept. of Fisheries and Oceans, Environment Canada)
Soils and Geomorphology (Alberta Environment; BC Ministry of Environment)
Land Ownership (Alberta Energy, BC Ministry Energy, Mines & Natural Gas)
Archeological & Paleontological Resources (Alberta Culture and Community; BC Ministry of Cultural Development)

Risk parameters are only defined within the Project boundary. Risk parameters fall into three separate categories defining:
Socio/Economic Project Risks
Environmental Project Risks
Project Construction Risks

Parameter selection and inclusion within the QRAF may be defined by a third party seeking the risk assessment or may alternatively be mandated by government regulations or other sources. Parameters encompass aspects of Project risk deemed important to review and where applicable mitigate appropriately. Additional parameters may be recommended for the QRAF but final review for inclusion in the application submission can be by the third party requesting the risk assessment.

Risk parameters may optionally be added to the QRAF upon review from regulatory authorities, stakeholder concerns or when additional data from third-party sources such as field assessment programs or other public/private consultation become available.

Field assessment programs and public/private industry consultation programs may include but are not limited to;
Wildlife Field Assessment Programs
Vegetation Field Assessment Programs
Archeological & Paleontological Resource Field Assessment Programs
Fisheries, Water Course and Wetland Field Assessment Programs
Geomorphological and Soil Field Assessment Programs
First Nation (FN) Consultation and Field Assessment Programs
Stakeholder Consultation and Field Assessment Programs
Project Construction Surveying Field Assessment Programs

Project consultation may be conducted by third parties such as with First Nations (FN), government, stakeholders/public and other groups affected or potentially affected by the proposed Project. These groups may identify risk parameters and rank their importance within the Project area. Project consultation can be a valuable step in addressing Project risks.

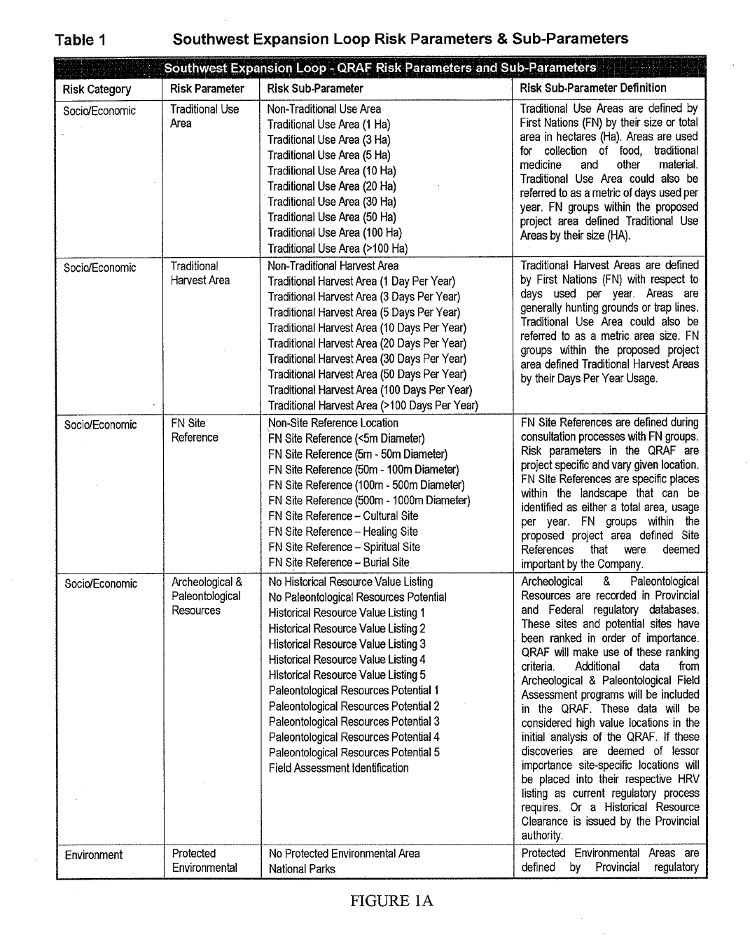

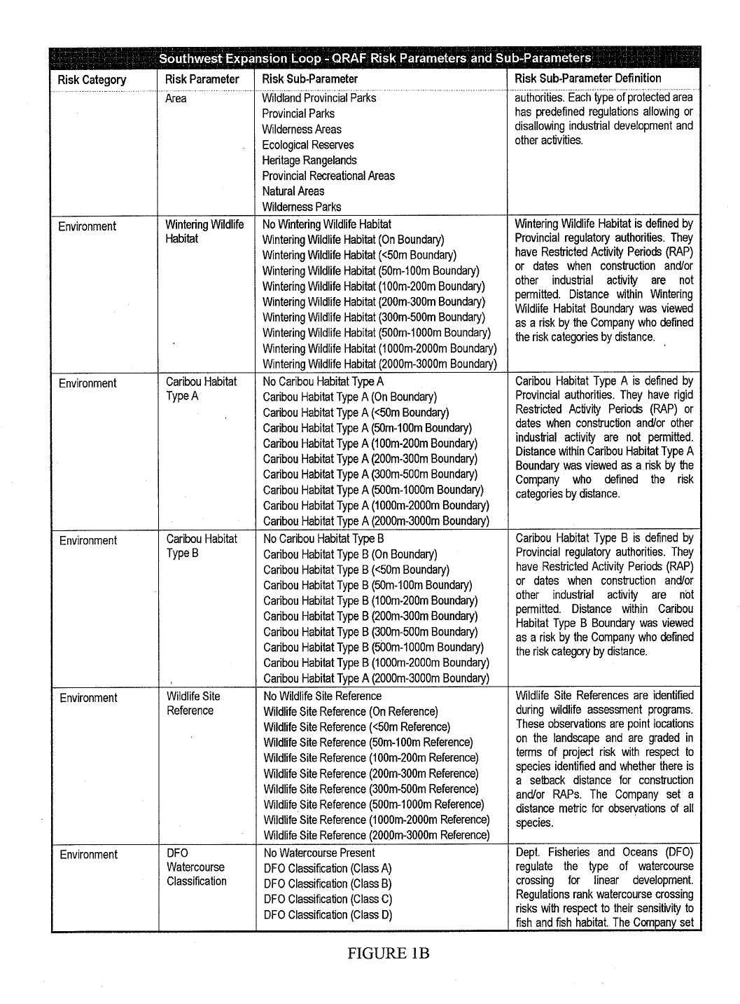

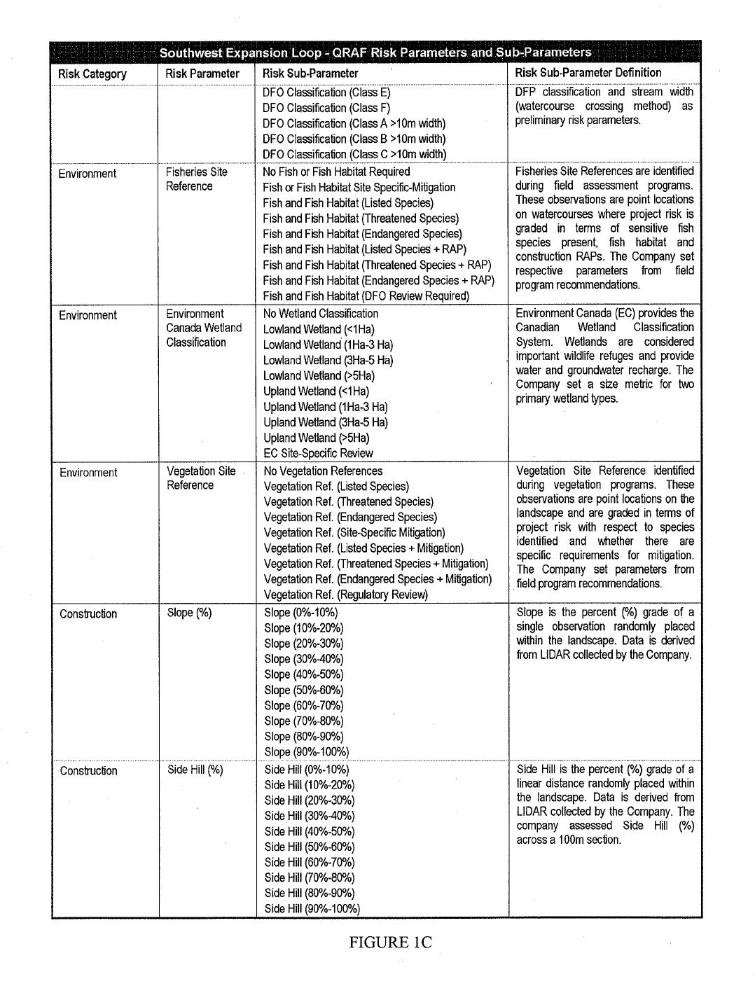

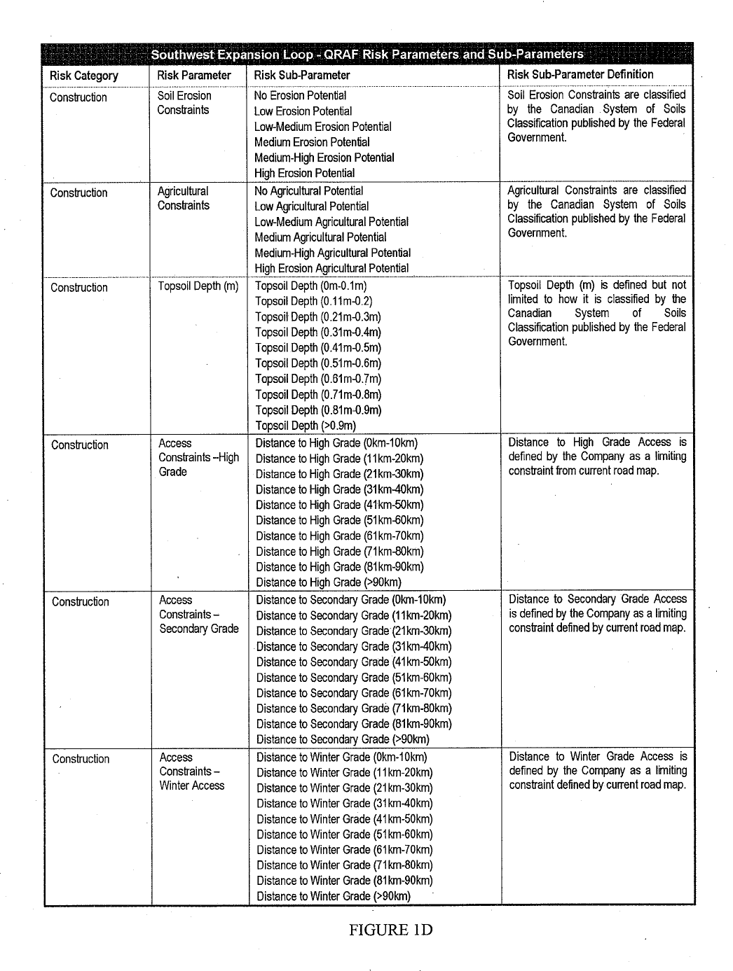

Southwest Expansion Loop risk categories, parameters and sub-parameters for the initial QRAF are presented in Table 1 shown in FIG. 1. Risk parameter definitions are provided by the party requesting the risk assessment to define their perspective of Project risk for mitigation where applicable.

Risk parameter ranking may primarily be defined by the party requesting the risk assessment. Additional parameter ranking processes may be conducted after initial consultation with third parties such as First Nation, Stakeholder Groups and Field Assessment Programs.

Risk Parameter Scale and Score

The scale associated with sub-parameters and risk ranking processes can be ordinal, continuous or categorical/discrete. The risk scale is unique to the risk parameter and risk scores are assigned to sub-parameter classes.
Ordinal risk scales may be characterized by a score of 1 through 10 in certain embodiments, where 10 is considered an order of magnitude ten times higher in risk score than 1. The scale is flexible and can vary from small values to high values; all that is assumed is the order of magnitude.
Continuous risk scales may be expressed as a distance (km), area (Ha) or other metric. A high risk continuous parameter may comprise either negative or positive values and the risk magnitude is characterized by the parameter definition. For example, a distance to metric for a given parameter could be high at either large or small physical values.
Categorical/Discrete scales are used to contrast one sub-parameter to another. In certain embodiments, there is no order of magnitude associated with risk, but there can be purely a discrete entity used within the modelling process to contrast within-parameter risk.

Risk Ranking Process

Risk ranking of sub-parameter classes may be conducted by the party requesting the risk assessment. The ranking process involves the identification and selection of parameters and sub-parameter classes for the QRAF as described in Table 1. Amendments are possible when additional Project data collected during consultation sessions or field assessment work becomes available. Risk ranking may be conducted by one or more individuals representing the party of interest.

To minimize discrepancies between risk scores ranked by multiple representatives, a survey can be conducted where individuals rank each sub-parameter and the average or median score is used within the QRAF. Each Company can view Project risks differently as inherent to activities that characterize a Project and may or may not be conducted. Flexibility for risk ranking sub-parameters is necessary and can be project-specific to demonstrate a step-wise process or risk assessment and where applicable mitigate for regulatory review.

Amendments and Additions

Data arising from consultation and/or field assessment programs may be included as additional parameters and ranked in order of risk by the party requesting the risk assessment or upon recommendations from third-party organizations conducting the consultation and/or field assessment program. Ultimately, the party requesting the risk assessment may have final review and discretion to change or modify recommendations; however, these decisions may be documented and submitted for regulatory review.

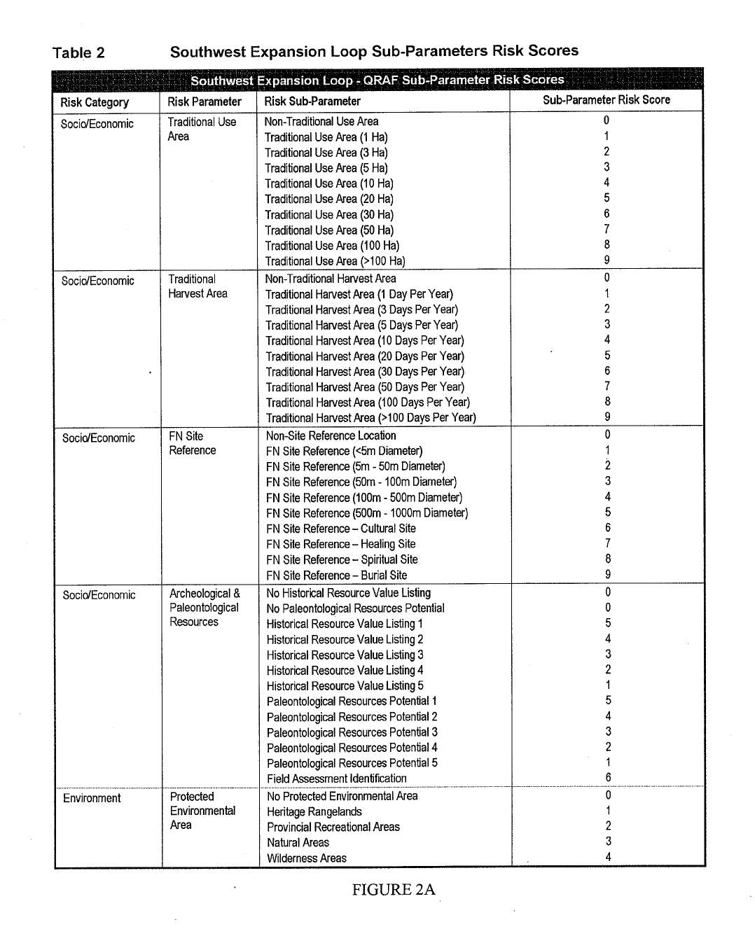

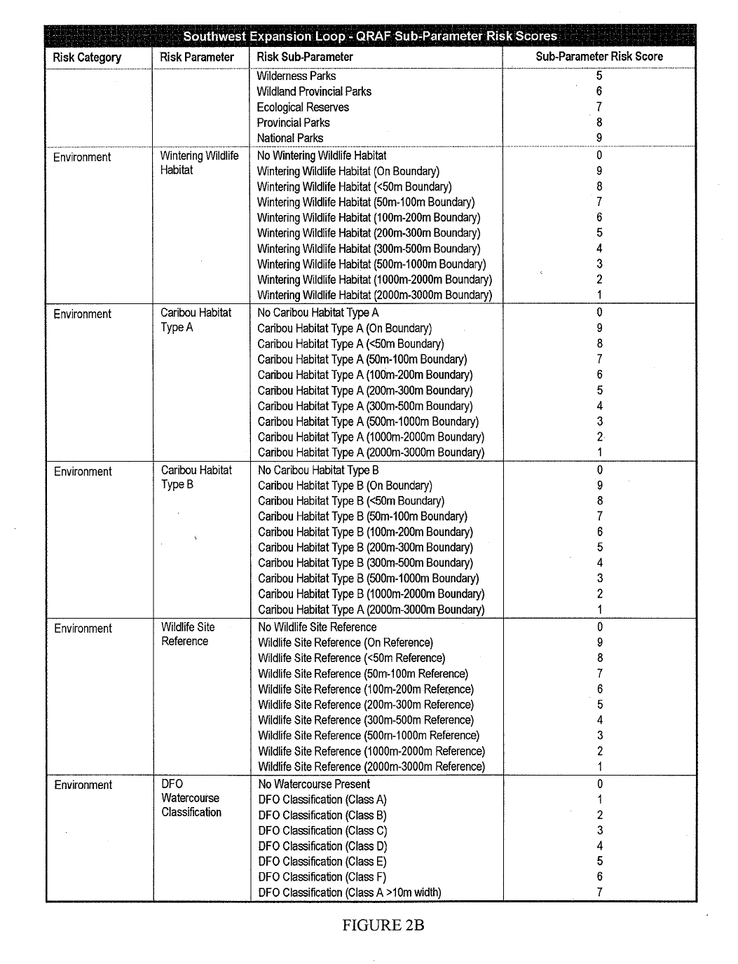

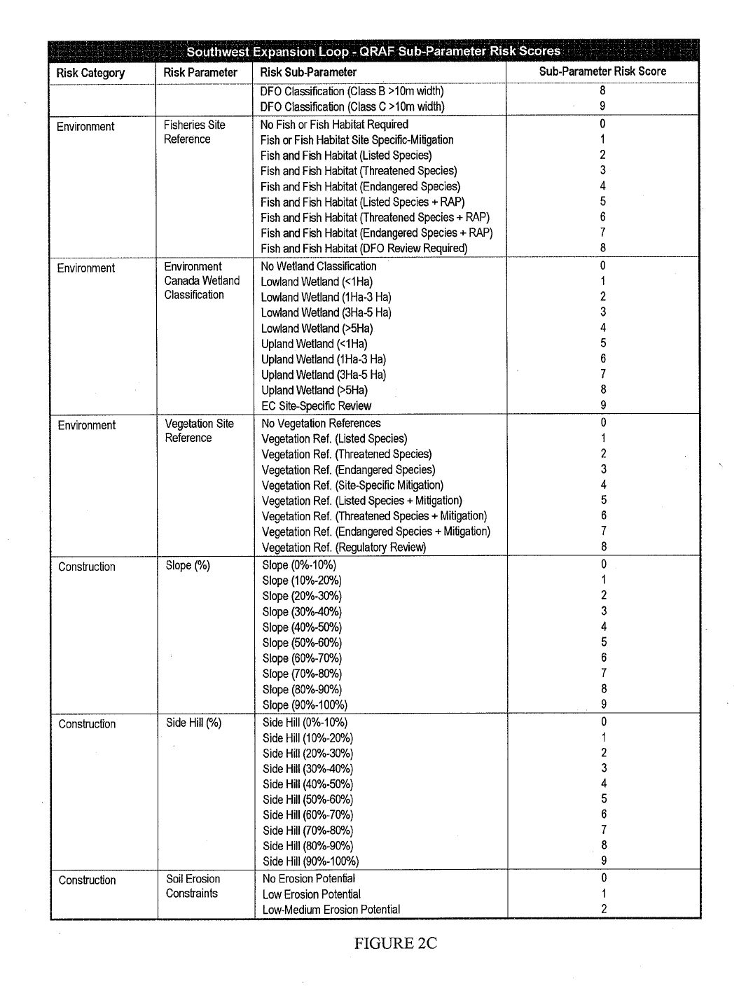

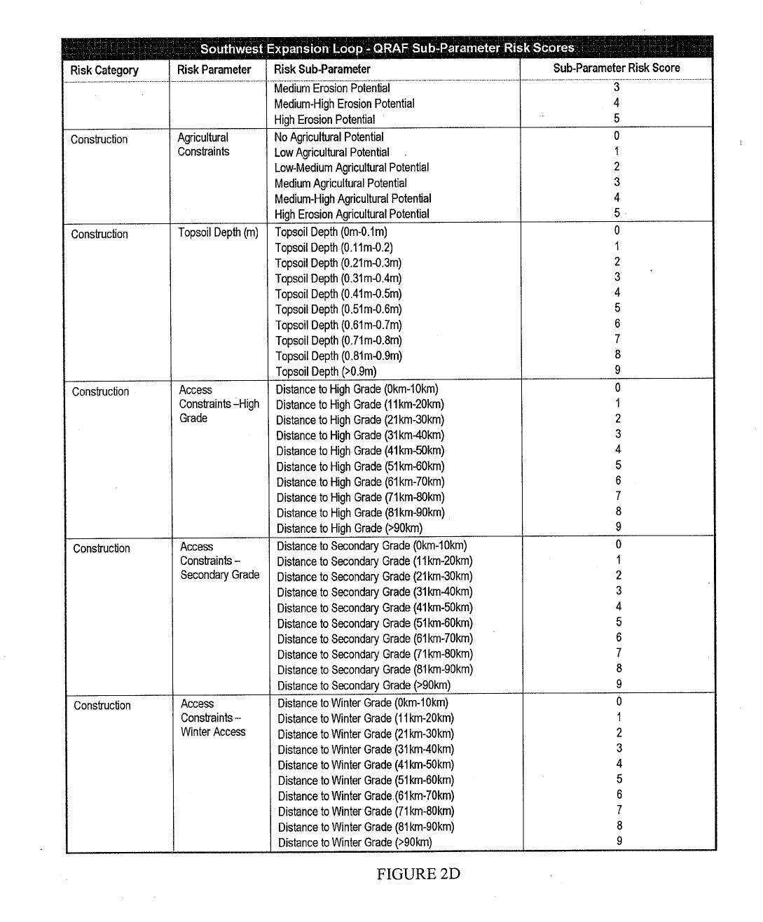

Southwest Expansion Loop sub-parameter risk ranking was conducted on an ordinal scale for the initial QRAF. Risk scores for sub-parameters are presented in Table 2 shown in FIG. 2.

Geographic Information System (GIS) data can be derived from digital layer files that characterize risk parameters and sub-parameters across the Project landscape. Data may either be acquired from remote sensing work conducted by a third party, purchased from third-party data sources or acquired through consultation and/or field assessment programs.

Data Acquisition

Data for the development of the QRAF may be acquired using GIS software. The Project area is defined along with respective data layers representing risk parameters and sub-parameters. Observations may be taken within both proposed and alternate lands. Each observation has a unique record of risk parameter, sub-parameter and risk score.

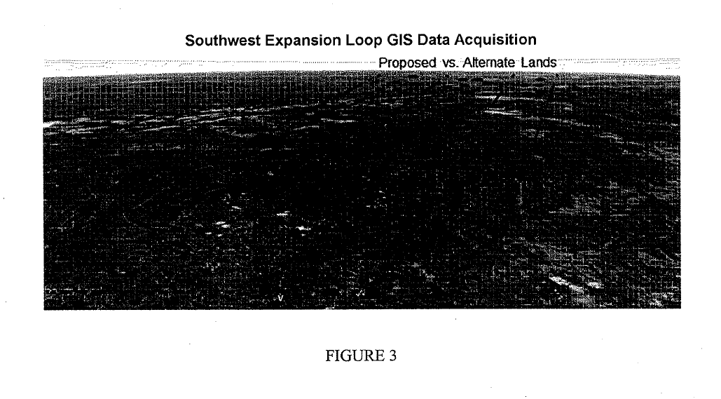

It is important to acknowledge that quantitative risk assessment can only be conducted within the proposed Project area from which data was collected. A revised QRAF will have to be constructed if the Project area is expanded or reduced. FIG. 3 provides a visual interpretation of a GIS data collection process.

Sampling Intensity

GIS data sampling is conducted using a stratified approach to ensure equal landscape representation. The level of resolution required is defined by the GIS software and digital data layers representing risk parameters and sub-parameters. Each observation within the GIS software is circular and represents a given area on the landscape, typically, although not limited to, 0.15 km².

The exemplary Southwest Expansion Loop encompasses a total area of 600 km², which comprises 100 km² of proposed lands and 500 km² of alternate lands. Using a stratified approach where observations are not allowed to overlap, a total of 4000 observations may be required to sample the entire Project area (600 km²). A total of 800 observations was generated for proposed lands and 3200 for alternate lands, ensuring >98% representation of the Project area.

Quantitative Risk Assessment Function

The Quantitative Risk Assessment Function (QRAF) process incorporates a step-wise approach to develop both initial and final QRAF products. Products include the statistical analysis and spatial representation in the form of maps. Final products may be loaded into hand held devices for use during planning and routes exercises or field assessment programs.

Model Development

QRAF's make use of both binary and multinomial models and also have the potential to accommodate several statistical distribution families. QRAF may include fixed effects and random effects modeling techniques.

Statistical modeling techniques employed may include but are not limited to the following:
Binary Logistic Regression, Ordinal Logistic Regression, Multinomial Logistic Regression;
Generalized Linear Models, Mixed Effects Regression, Random-Effects Regression;
Poission Regression, Negetaive Binomial Regression, Simple Linear Regression.

Statistical distributions families employed may include but are not limited to the following:
Normal, Poisson, Weibull, Binomial, Negative Binomial, Exponential, Chi-Square, Log-Normal, Gaussin, Inverse Gaussin or Gamma.

The selection of the appropriate model and distribution is dictated by the data and can be project-specific.

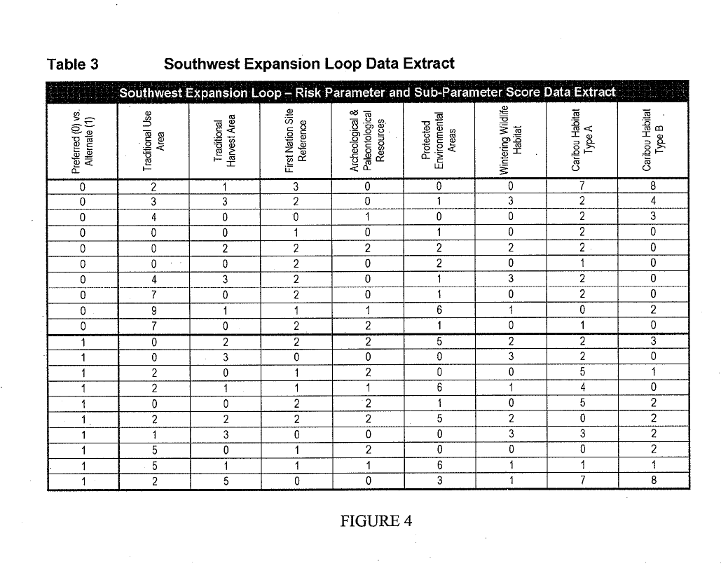

Data for the Southwest Expansion Loop Project conform to a binary data where a zero (0) is assigned to observations within proposed lands and a one (1) assigned to observations from within alternate lands. An extract of the data used for the development of the QRAF is presented in Table 3 shown in FIG. 4.

Binary Logistic Regression or Generalized Linear Regression (Binomial Family) may be used to develop the QRAF. Binary Logistic Regression was selected to analyze the Southwest Expansion Loop data as it is commonly used to analyze count data with a binomial distribution (Cameron and Trivedi 2007).

Statistical Analysis

Quantitative Risk Assessment Function (QRAF) for the Southwest Expansion Loop data was constructed using logistic regression to estimate coefficients for each risk parameter (Hosmer and Lemeshow 2000). The QRAF model took the following structure:

w(x)=exp(β₁x₁+β₂x₂+ . . . βᵢxᵢ)

where w(x) represents the quantitative risk assessment function, βᵢ represents the coefficient on the xᵢ risk parameter. A simplified version of the model may be expressed as follows.

$$Pr ( Risk ) = \frac{function ( \begin{matrix}Traditional Use + \\ Traditional Harvest + … + Winter Access\end{matrix} )}{1 + function ( \begin{matrix}STraditional Use + \\ Traditional Harvest + … + Winter Access\end{matrix} )}$$

Model significance and fit were evaluated using Wald's Chi-square statistic and Hosmer and Lemeshow goodness-of-fit statistic, respectively. A significant (p<0.05) Wald's Chi-square statistic and non-significant Hosmer Lemeshow statistic (p>0.05) indicates good model performance (Hosmer and Lemeshow 2000).

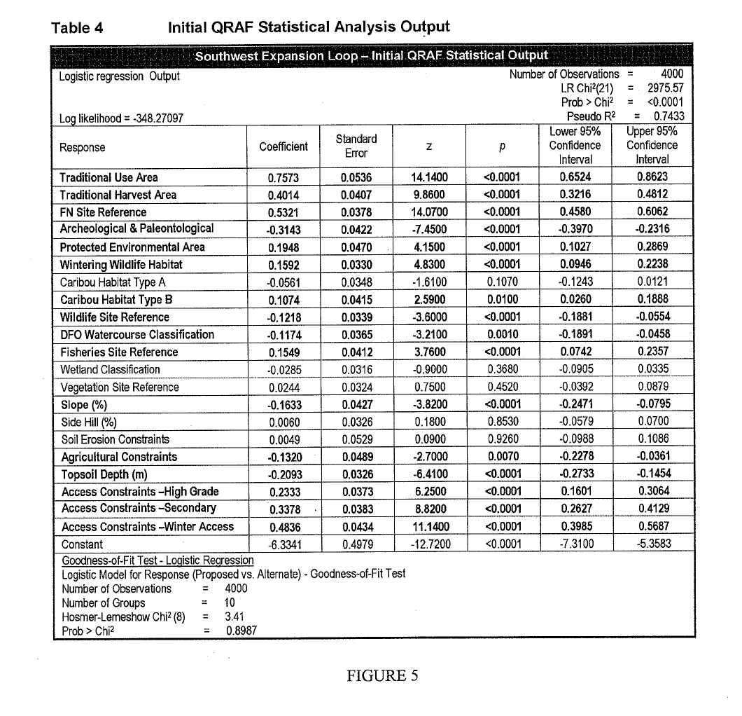

All analyses were conducted in the statistical program STATA (2011). Statistical analysis output for the initial QRAF is presented in Table 4 shown in FIG. 5.

Initial QRAF Statistical output indicates several significant parameters (bold) within the initial QRAF (Table 4). Significant parameters are tested at the significance level of alpha (p-value)<0.05. Goodness-of-fit results indicate a non-significant Hosmer-Lemeshow statistic (Chi²=3.41, p=0.8987), indicating adequate fit and performance of the QRAF to the risk parameter data.

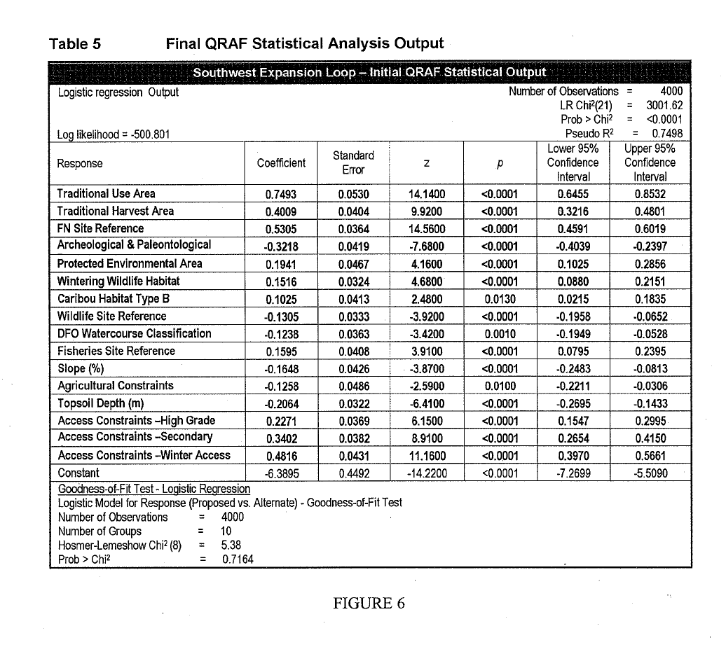

Non-significant risk parameters are removed from the model as there is no statistical difference between proposed and alternate lands. Table 5, shown in FIG. 6, represents the final QRAF with non-significant risk parameters removed.

The initial model may be kept in its current format and map products based on the complete list of risk parameters may be developed. For the purpose of mitigating only significant risk parameters the QRAF model was minimized.

The final QRAF statistical output (Table 5) includes only the significant risk parameters (p<0.05). Goodness-of-fit results indicate a non-significant Hosmer-Lemeshow statistic (Chi²=5.38, p=0.7164), indicating adequate fit and performance of the QRAF to the risk parameter data.

Results and Interpretation

Logistic regression coefficients indicate whether the proposed or alternate lands have higher or lower risk (Table 5). Results may be summarized as follow:
Traditional Use Areas have lower risk in proposed lands than alternate lands as the regression coefficient is positive (β=0.7493).
Traditional Harvest Areas have lower risk in proposed lands than alternate lands as the regression coefficient is positive (β=0.4009).
First Nation Site Reference have lower risk in proposed lands than alternate lands as the regression coefficient is positive (β=0.5305).
Archeological and Paleontological Resources have higher risk in proposed lands than alternate lands as the regression coefficient is negative (β=−0.3218).
Protected Environmental Areas have lower risk in proposed lands than alternate lands as the regression coefficient is positive (β=0.1941).
Wintering Wildlife Habitat have lower risk in proposed lands than alternate lands as the regression coefficient is positive (β=0.1516).
Caribou Habitat Type B have lower risk in proposed lands than alternate lands as the regression coefficient is positive (β=0.1025).
Wildlife Site Reference have higher risk in proposed lands than alternate lands as the regression coefficient is negative (β=−0.1305).
DFO Watercourse Classification have higher risk in proposed lands than alternate lands as the regression coefficient is negative β=−0.1238).
Fisheries Site Reference have lower risk in proposed lands than alternate lands as the regression coefficient is positive (β=0.1595).
Slope (%) have higher risk in proposed lands than alternate lands as the regression coefficient is negative (β=−0.1648).
Agricultural Constraints have higher risk in proposed lands than alternate lands as the regression coefficient is negative (β=−0.1258).
Topsoil Depth (m) have higher risk in proposed lands than alternate lands as the regression coefficient is negative (β=−0.2064).
Access Constraints—High Grade have lower risk in proposed lands than alternate lands as the regression coefficient is positive (β=0.2271).
Access Constraints—Secondary Grade have lower risk in proposed lands than alternate lands as the regression coefficient is positive (β=0.3402).
Access Constraints—Winter Access have lower risk in proposed lands than alternate lands as the regression coefficient is positive (β=0.4816).

An important characteristic of the QRAF logistic regression analysis is the response variable and how the binary code was initially developed. In the example above, proposed lands were assigned a zero (0) and alternate lands assigned a one (1). This effects the interpretation of results as risk is contrast to proposed lands.

The contrast may be made in reverse order which would not impact the outcome of the analysis or regression coefficients, with the exception of reversing the positive and negative sign on the coefficient. Consideration should be given to results interpretation when transferring the regression coefficients to GIS software for developing thermal mapping products characterizing total Project risks.

Spatial Risk Analysis

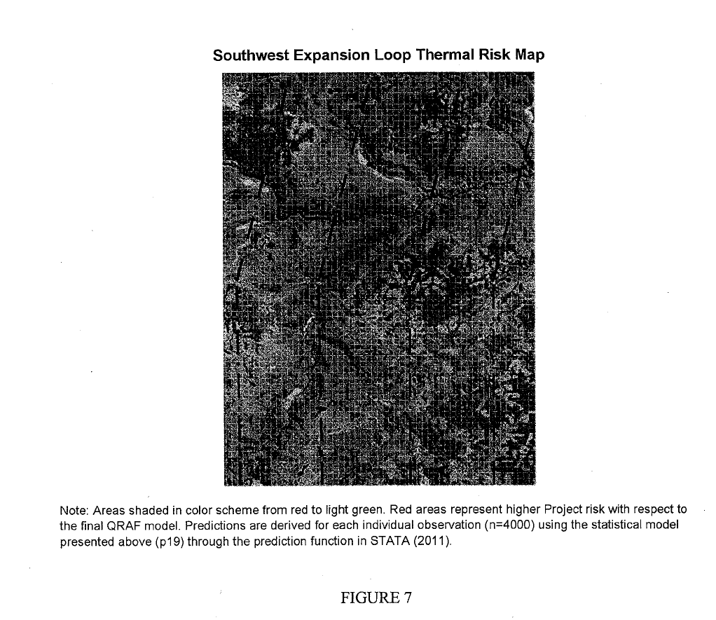

FIG. 7 presents a thermal map of total Project risk identified in Table 5. Mapping products could be reviewed with respect to social/economic, environmental and construction risks separately if required.

Risk Mitigation Process

The final QRAF (Table 5) indicates that six of the sixteen significant risk parameters have higher risk on proposed lands in contrast to alternate lands. The party requesting the risk assessment has several options to propose adequate mitigation for these risk parameters. It can be to the discretion of the party to mitigate Project risk.

Reviewing the percentage of observations within each sub-parameter class provide a means of determining which sub-parameters require Project-specific mitigation. This percentage can be tested for significant differences.

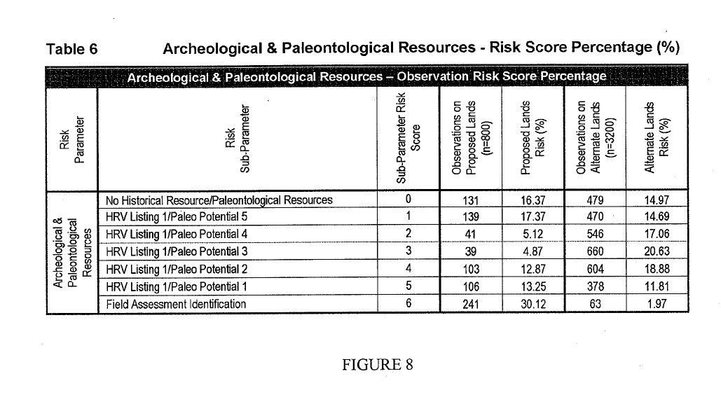

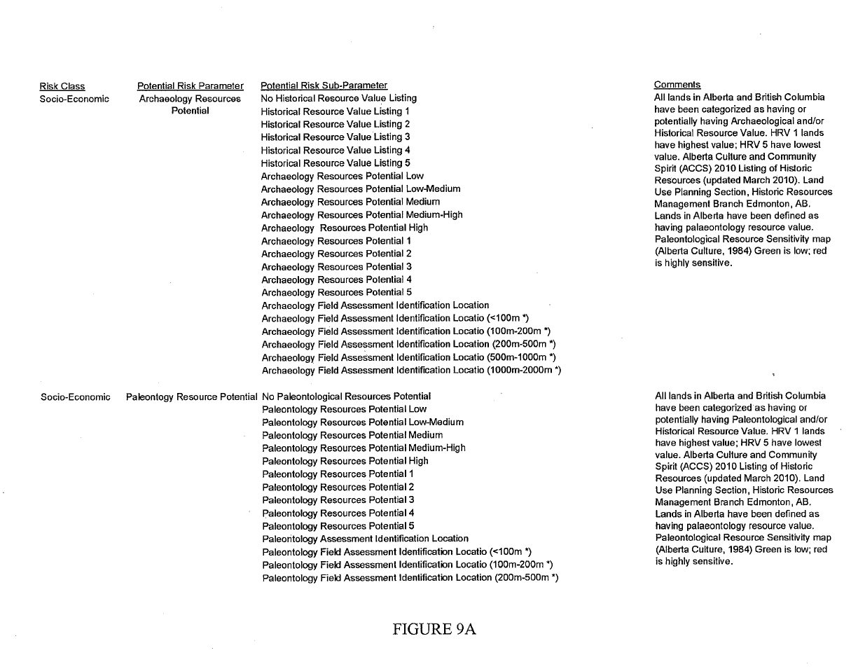

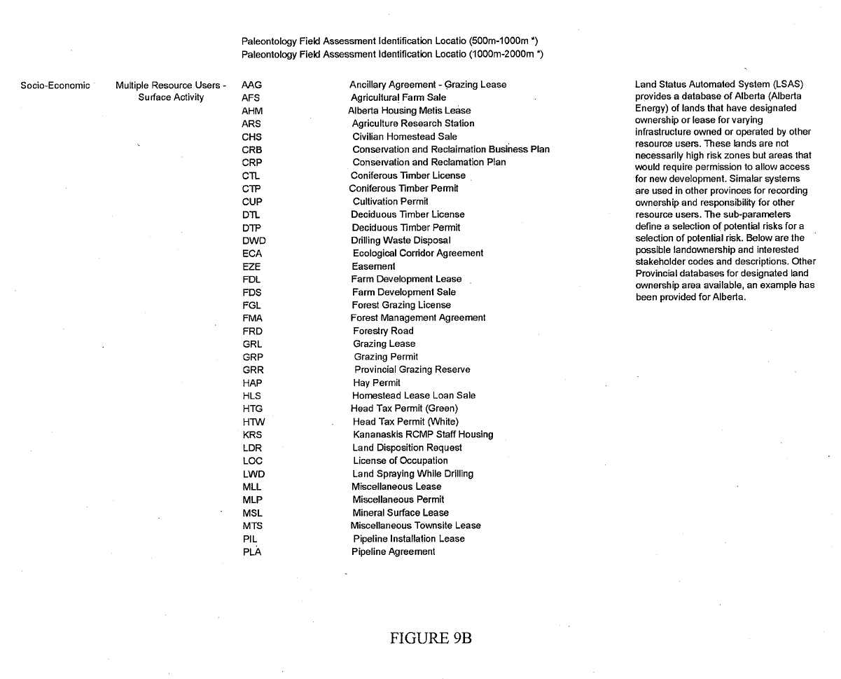

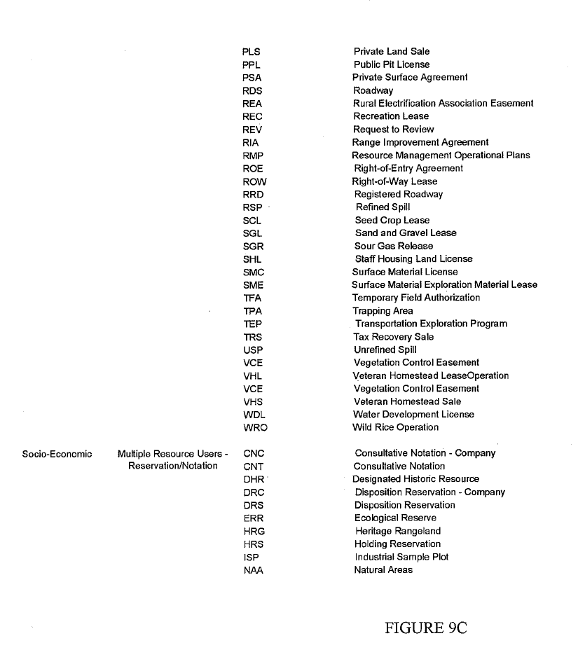

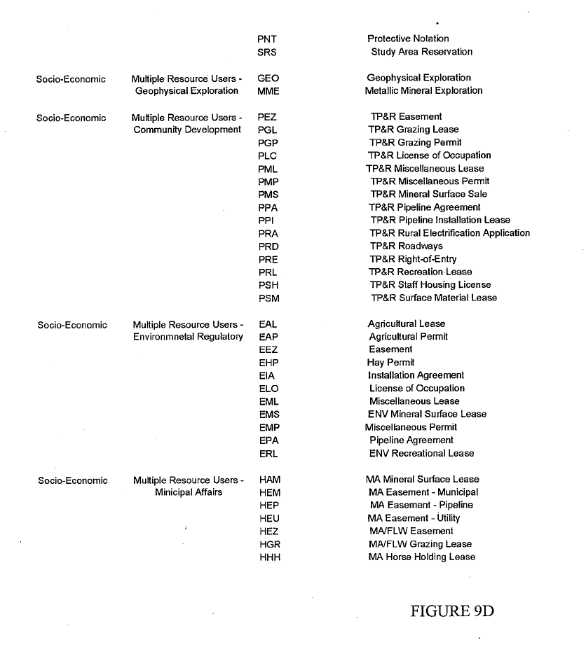

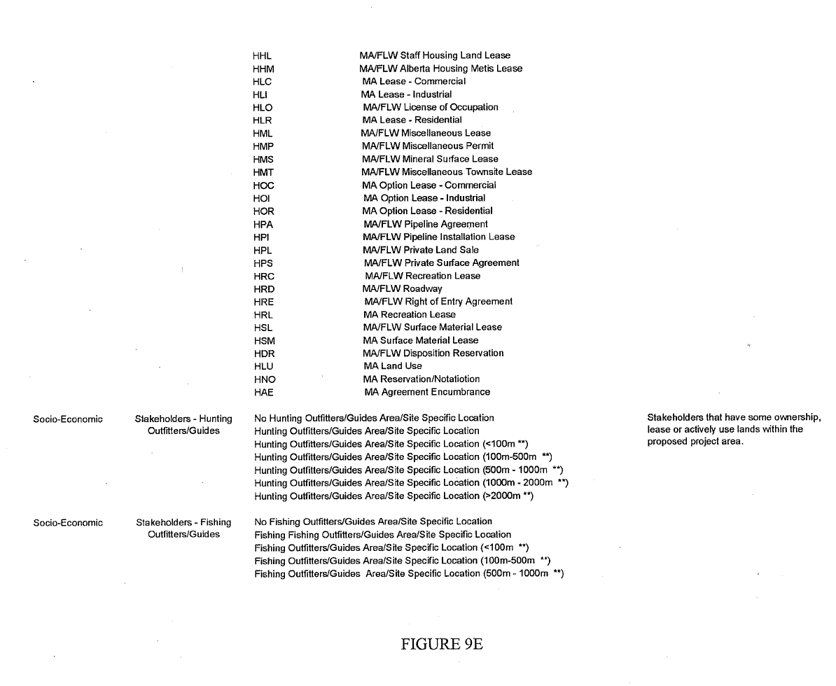

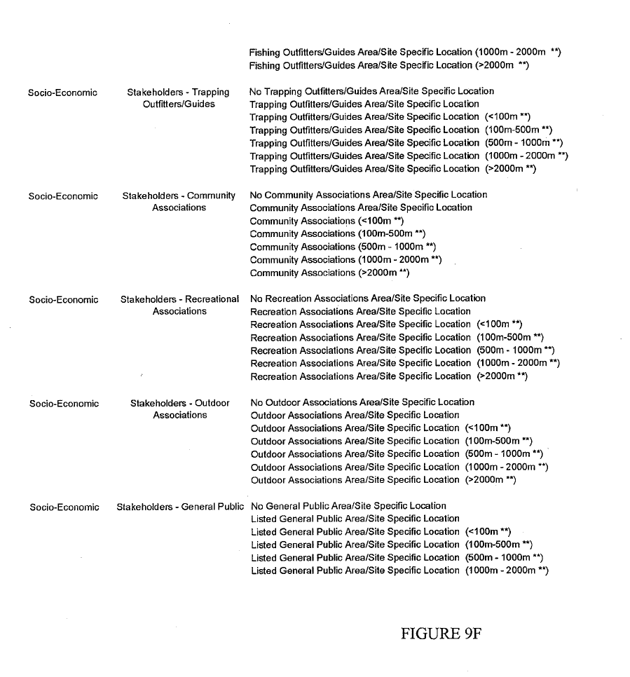

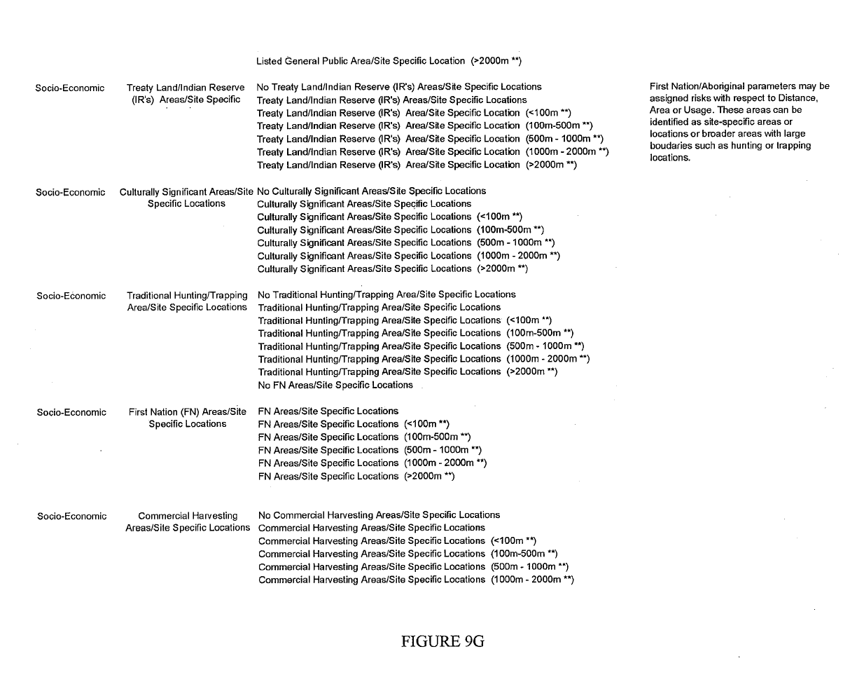

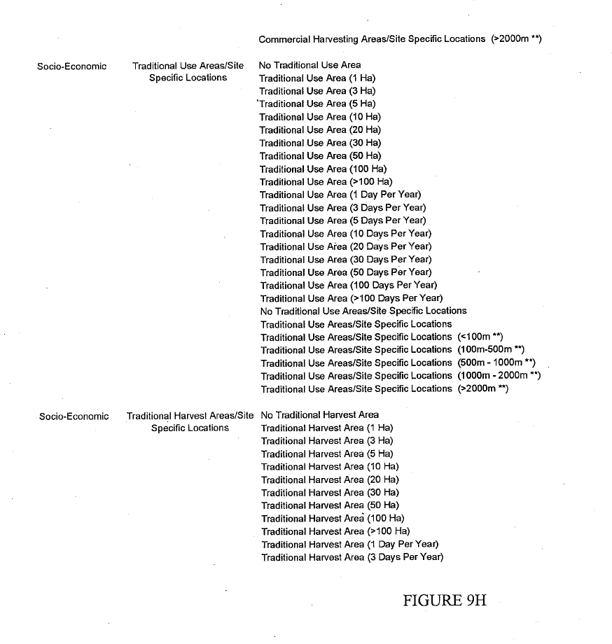

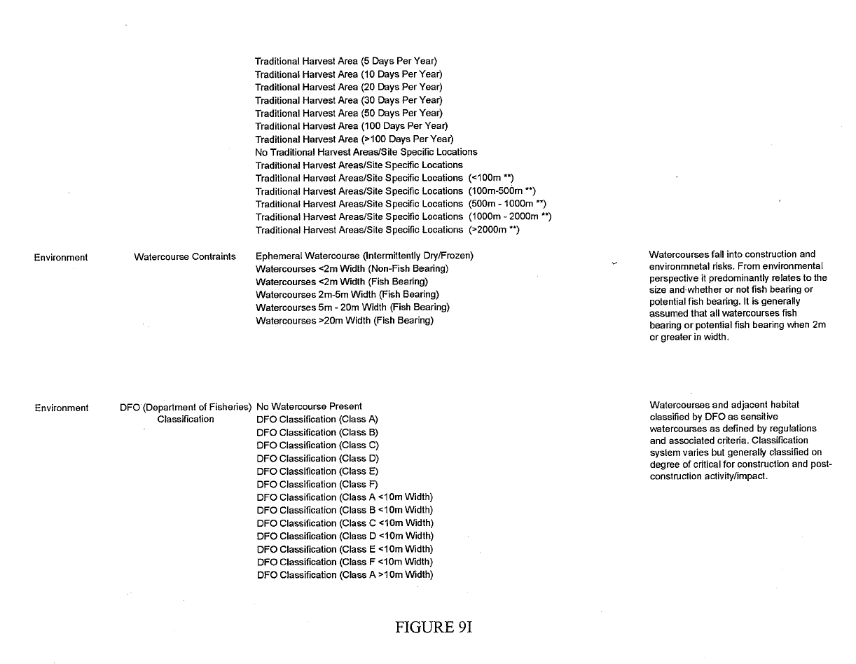

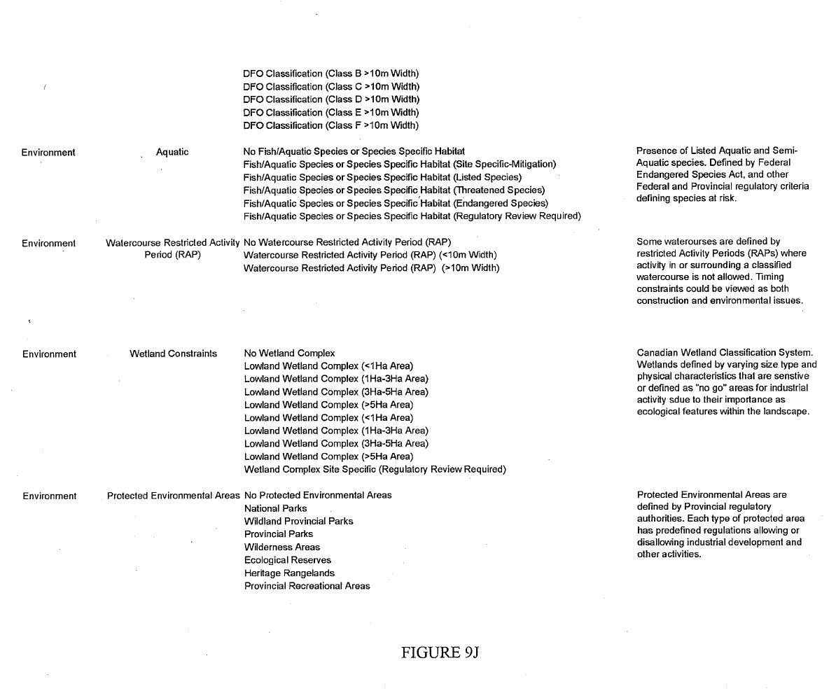

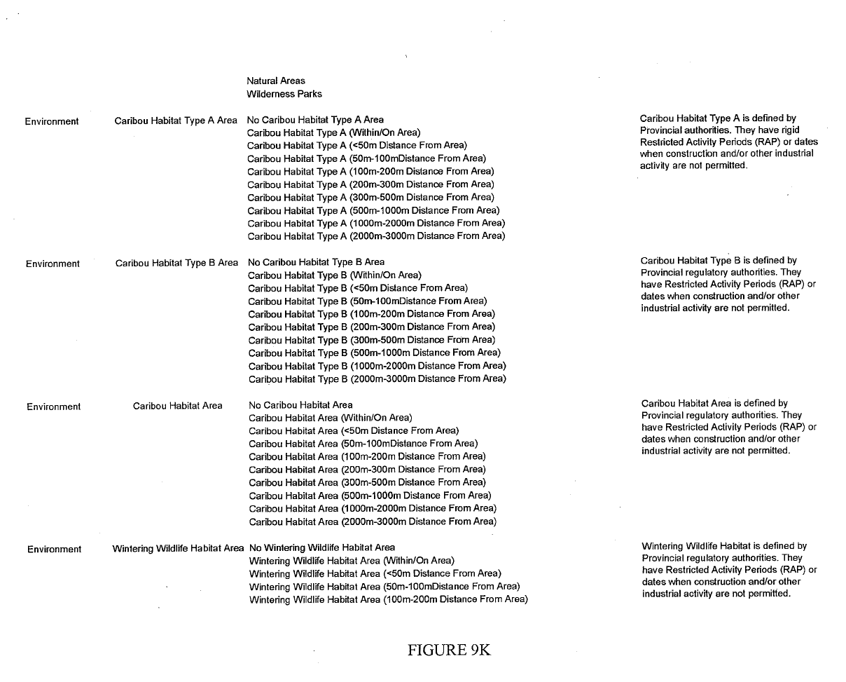

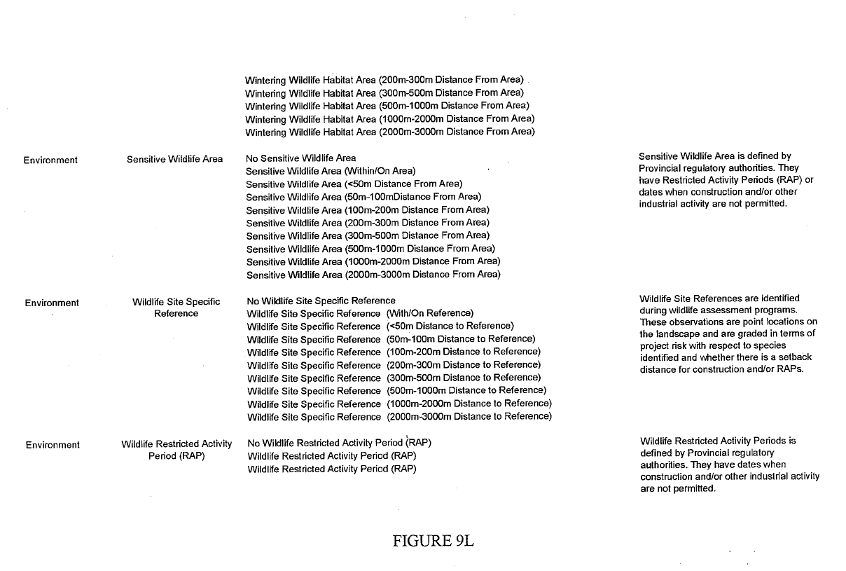

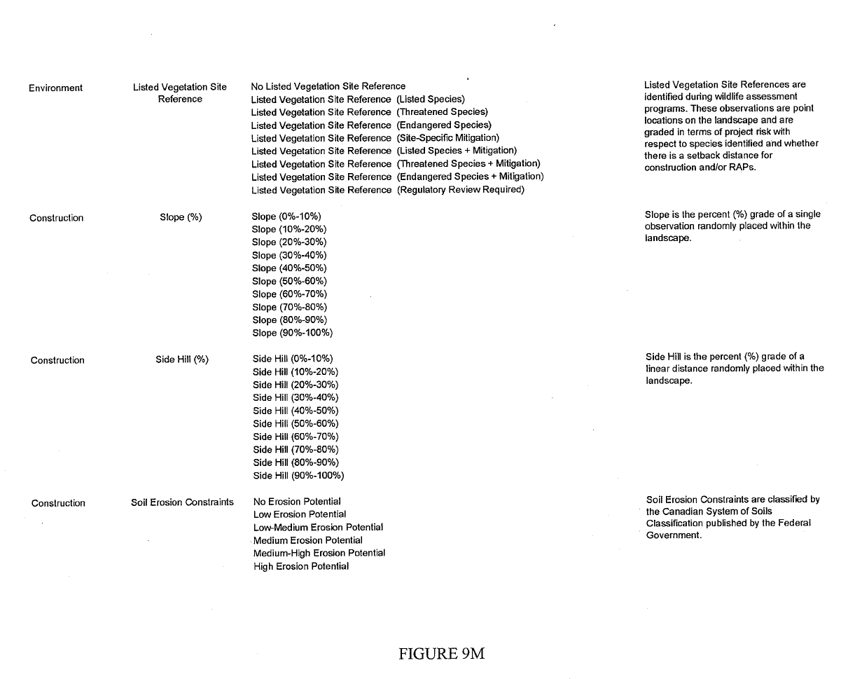

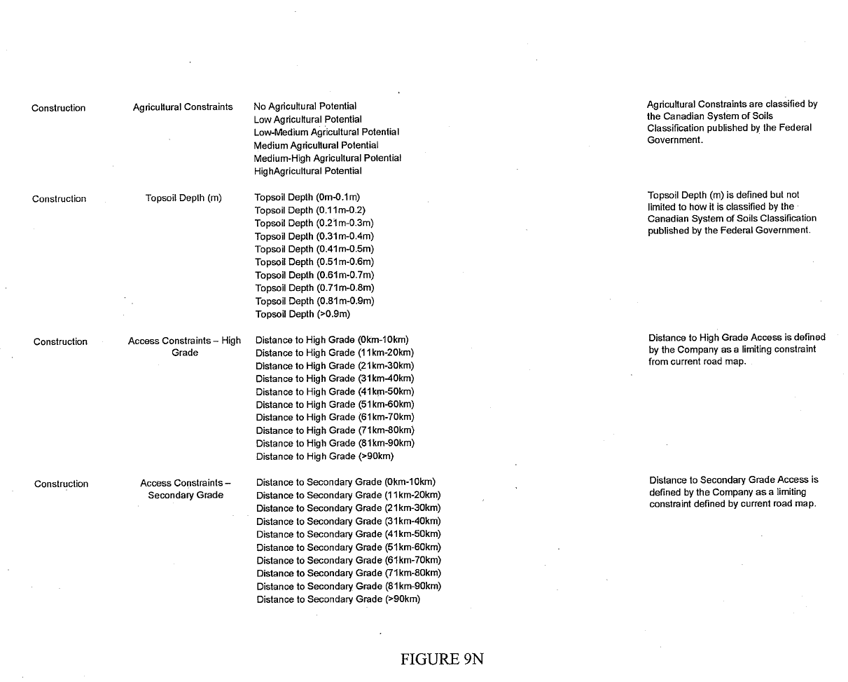

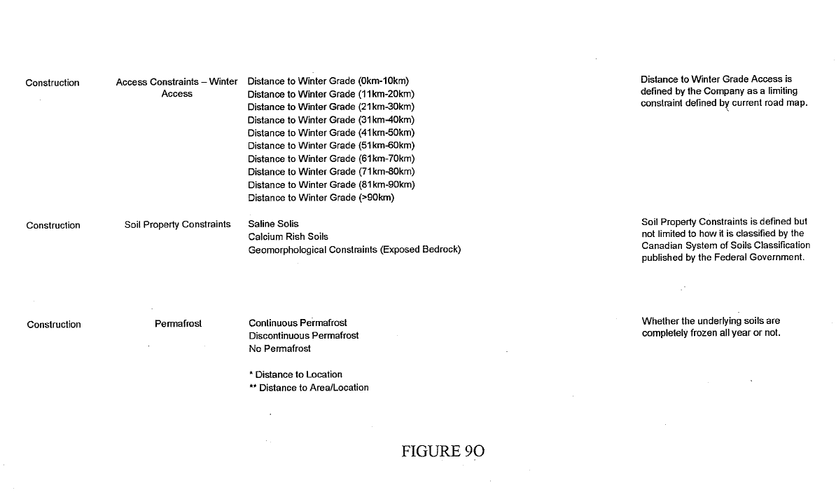

Archeological & Paleontological Resources were determined statistically different between proposed and alternate lands (p<0.0001) an example or sub-parameter risk mitigation was provided in Table 6 shown in FIG. 8.

Sub-Parameter Risk Identification

Two-proportion tests are commonly used to identify significant differences between percentages of two groups. The test statistic of the two-proportion test is the Z-value. For large sample sizes (n>30), this Z-value follows the same normal distribution as the well-known standardized z-value for normally distributed data (Kuehl 2000).

A two-proportion test may be employed to identify which sub-parameter classes are statistically different between proposed and alternate lands. Field Assessment Identification shows the greatest difference between the proportion of observation in proposed (0.3012) and alternate (0.0197) lands (Table 6).

Two-Proportion Test

The Z-value is calculated as:

$$z = \frac{( p 1 - p 2 ) - 0}{{\hat{σ}}_{p 1 - p 2}}$$

where (p1−p2) is the observed difference between the sample proportions and \hat{σ}ₚ₁₋ₚ₂ is the standard error (SE) of the difference between the two proportions. Proportions are calculated as follows (Table 6):

Proposed Lands=241 observations/800 observations=0.3012 or 30.12%

Alternate Lands=63 Observations/3200 observations=0.0197 or 1.97%

Standard Error is calculated as follows:

$${\hat{σ}}_{p 1 - p 2} = \sqrt{\frac{( p 1 ) ( 1 - p 1 )}{n 1} + \frac{( p 2 ) ( 1 - p 2 )}{n 2}}$$

$${\tilde{σ}}_{p 1 - p 2} = \tilde{\sqrt{\frac{( 0.3012 ) ( 1 - 0.3012 )}{800} + \frac{( 0.0197 ) ( 1 - 0.0197 )}{3200}}} = 0.000525$$

To test for a significant difference between proposed versus alternate lands the z-value is calculated.

$$z = \frac{( 0.3012 - 0.0197 ) - 0}{0.000525} = 536.19$$

The calculated Z-value of 536.19 is compared with the critical Z-value that must be exceeded to reject the null hypothesis that proposed and alternate proportions are equal. In this case, the sample size is large enough (n>30) to assume that the Z distribution follows the standardized and normally distributed z distribution. An Alpha of 5 percent (or 0.05) corresponds to a critical value of +/−1.96 for a two-tailed test.

The calculated Z-value of 536.19 is larger than the critical Z-value of +1.96. The null hypothesis that the proposed and alternate proportions are equal is rejected and we conclude that proposed lands have higher risk of Archeological & Paleontological Resources Field Assessment Programs in contrast to alternate lands.

This process is carried out for all other possible contrasts between sub-parameter classes for significant risk parameters.

It will be appreciated that reference to parameters herein may encompass sub-parameters. Further, modifications, changes and obvious improvements may be made to the processes, methods and systems herein and within the scope of the invention and contemplations of the inventors.

### REFERENCES

Cameron, A. C and Trivedi, P. K. (2007), Regression Analysis of Count Data, (6th ed.), New York (NY), Cambridge University Press.
Hosmer, D. W., and S. Lemeshow 2000, Applied logistic regression, 2nd edition, John Wiley & Sons Inc. USA.
Kuehl, R. O. (2000), Design of Experiments: Statistical Principles of Research Design and Analysis (2nd ed.), Pacific Grove (CA), Brooks/Cole.
StataCorp 2011, Stata Statistical Software: Release 12, College Station, Tex., StataCorp LP.

We claim:

1. A method for producing a quantitative risk assessment of one or more geographical development projects associated with one or more geographical regions comprising:
categorizing project risks into a series of risk parameters;
collecting geographic information system (GIS) data on the one or more geographical regions;
linking the GIS data to the risk parameters;
using a weighing/scoring of the risk parameters to produce one or more quantitative risk assessment functions (QRAFs) based on the linked GIS data; and
using the one or more QRAFs and collected GIS data to produce the quantitative risk assessment of the one or more geographical development projects.

2. The method according to claim 1, wherein the one or more geographical development projects are comprised of a proposed project and an alternate project.

3. The method according to claim 1, wherein the produced quantitative risk assessment compares the risks associated with each project to determine a comparative risk assessment.

4. The method according to claim 1, wherein the series of risk parameters comprise parameters representing socio-economic, environmental, and/or construction risks.

5. The method according to claim 1, wherein the geographical development projects are renewable energy projects or non-renewable energy projects.

6. The method according to claim 1, wherein the risk parameters further comprise sub-parameter categories.

7. The method according to claim 1, wherein the quantitative risk assessment comprises one or more risk maps representing one or more of the project risks associated with the one or more geographical development projects.

8. The method according to claim 7, wherein each of the one or more risk maps represent one or more of the parameters in the series of risk parameters associated with the project risks of the one or more geographical development projects.

9. The method according to claim 1, wherein the one or more QRAFs employ risk ranking processes that are ordinal, continuous, or categorical/discrete.

10. The method according to claim 1, wherein the one or more QRAFs employ binary and multinomial models for risk assessment.

11. A risk assessment system for producing a quantitative risk assessment of one or more geographical development projects associated with one or more geographical regions comprising a non-transitory computer readable memory having recorded thereon statements and instructions for execution by a computer to carry out:
categorizing project risks into a series of risk parameters;
receiving geographic information system (GIS) data on the one or more geographical regions;
linking the GIS data to the risk parameters;
using a weighing/scoring of the risk parameters to produce one or more quantitative risk assessment functions (QRAFs) based on the linked GIS data; and
using the one or more QRAFs and collected GIS data to produce the quantitative risk assessment of the one or more geographical development projects.

12. The system according to claim 11, wherein the one or more geographical development projects are comprised of a proposed project and an alternate project and the produced quantitative risk assessment compares the risks associated with each project to determine a comparative risk assessment.

13. The system according to claim 11, wherein the series of risk parameters comprise parameters representing socio-economic, environmental, and/or construction risks.

14. The system according to claim 11, wherein the geographical development projects are renewable energy projects or non-renewable energy projects.

15. The system according to claim 11, wherein the risk parameters further comprise sub-parameter categories.

16. The system according to claim 11, wherein the quantitative risk assessment comprises one or more risk maps representing one or more of the project risks associated with the one or more geographical development projects.

17. The system according to claim 16, wherein each of the one or more risk maps represent one or more of the parameters in the series of risk parameters associated with the project risks of the one or more geographical development projects.

18. The system according to claim 11, wherein the one or more QRAFs employ risk ranking processes that are ordinal, continuous, or categorical/discrete.

19. The system according to claim 11, wherein the one or more QRAFs employ binary and multinomial models for risk assessment.

20. A method for quantifying project risks and constraints of a project development for generating a compensation assessment comprising offsets and/or conservation allowances for regulatory approval.
